(19) United States
(12) Patent Application Publication
(10) Pub. No.: US 2024/0270491 A1
(43) Pub. Date: Aug. 15, 2024

(54) A TRACK SYSTEM FOR A STORAGE AND RETRIEVAL SYSTEM

(71) Applicant: Ocado Innovation Limited, Hatfield, Hertfordshire (GB)

(72) Inventor: Joshua James BANNISTER, Hatfield, Hertfordshire (GB)

(73) Assignee: Ocado Innovation Limited, Hatfield, Hertfordshire (GB)

(21) Appl. No.: 18/568,503

(22) PCT Filed: Jun. 7, 2022
(86) PCT No.: PCT/EP2022/065402

§ 371 Date: Dec. 8, 2023

(30) Foreign Application Priority Data
Jun. 8, 2021 (GB) 2108197.1

(51) Int. Cl. B65G 1/04; B65G 1/06; E01B 25/28

(52) U.S. Cl. CPC B65G 1/0464; B65G 1/065; E01B 25/28

(57) ABSTRACT

A track system for a storage and retrieval system, the track system including a first set of tracks extending in a first direction and a second set of tracks extending in a second direction, the second direction being substantially perpendicular to the first direction, each of the first and second sets of tracks including a plurality of track elements, wherein at least a section of at least one track element of the first and/or second sets of tracks including a plurality of interdigitated slots such that the at least one track element is compliant.

The invention relates to a track system for an automated storage and retrieval system.

### BACKGROUND

The claimed invention is intended to provide improvements relating to automated storage and retrieval systems.

Thermal expansion and contraction in rigid structures, especially in large rigid structures, can be a problem. Although the expansion of each individual member in a structure is small, when the overall structure is large the cumulative displacement can be significant. If no provision is made for thermal expansion and contraction, relative movement in the structure can cause members to buckle and break.

Thermal expansion can be a problem in automated storage and retrieval systems with large rigid grid framework structures. The grid framework structure comprises a track system supported by a supporting framework structure. Within the supporting framework structure under the track system are stored stacks of storage containers.

In large grid framework structures, the track system in particular can be subject to thermal expansion and contraction.

A track system is typically formed from a number of track elements or sections of track that are cut at rights angles and joined together. Sometimes a gap is left in between the ends of adjacent tracks for the purpose of allowing thermal expansion of the track elements or sections. The cut of the track sections are such that the gap perpendicularly intersects the track. The joint at the intersections of track elements tends to present a small step to an oncoming vehicle or load handling device travelling on the tracks. When a vehicle approaches a track joint at the intersections, the wheels of the vehicle tend to snag or strike the edge of the tracks as it crosses the intersection.

The vertical displacement of the wheel as the vehicle travels across the intersections is exacerbated when there is a gap between the intersecting sets of rails or tracks. In this case, when a vehicle approaches a track joint, the wheel will sink in to the gap as it passes. Because of the narrow gap, as the wheel sinks down, it will strike the edge of the next section of the track. After the wheel rolls over the gap, it rises to the surface of the next section of the track.

Another solution to the problem of thermal expansion and contraction of the track system on a grid framework structure, that does not require gaps between end ends of adjacent tracks to allow for thermal expansion, is to use an expansion joint. Such an expansion joint is illustrated in FIG. 6. The expansion joint 2 comprises a sliding plate 4 that overlays the track, positioned at an interface between two track sections 6,8. The sliding plate 4 is fixed to a first track section 6, and rests upon and slides against a second track section 8 (not pictured). The two track sections 6, 8 can therefore move relative to one another, as the sliding plate 2 moves relative to and slides over the second track section 8. The sliding plate 2 compensates for thermal expansion, thermal contraction, and movement of the grid. However, there are several issues with this solution: the expansion joint is not scalable for different sizes of grid framework structure, the sliding motion of the sliding plate on the second track section causes wear, the raised profile of the sliding track causes shockloads to a load handling device passing over it and may cause inaccuracies in position and/or velocity measurements.

In addition to thermal expansion and contraction, the track system needs to account for other movements in the grid framework structure due to seismic activity, e.g. movement of the underlying track support.

### SUMMARY

The invention is a track system for a storage and retrieval system, the track system comprising a first set of tracks extending in a first direction and a second set of tracks extending in a second direction, the second direction being substantially perpendicular to the first direction, each of the first and second sets of tracks comprising a plurality of track elements, characterised in that at least a section of at least one track element of the first and/or second sets of tracks comprises a plurality of interdigitated slots such that the at least one track element is compliant.

The compliant track element allows for thermal expansion, contraction, and other movement in the track system and the underlying grid framework structure, such as movement resulting from seismic activity. A major advantage of using a compliant track element instead of a traditional expansion joint is that there are no sliding parts. The relative motion of sliding parts causes wear as the structure thermally expands or thermally contracts. For example, the sliding plate and the second track section of the prior-art expanding joint discussed above slide against each other, causing wear to both parts. The absence of sliding parts means that the compliant track element suffers less wear and can potentially have a longer operational life.

Another key advantage of using a compliant track element is the smooth profile. In contrast, the presence of the sliding plate in prior-art expansion joints means that the path for a load handling device moving over the joint is not smooth and continuous. As a load handling device passes over the sliding plate, there is a bump as a wheel of the load handling device mounts onto the sliding plate, and again when the wheel leaves the sliding plate. Although the vertical displacement of the wheel is quite small as the vehicle travels over the lip of the sliding plate, this up and down bumping impact to the wheels is a source of noise and vibration of the load handling device. Passing over the expansion joint applies a shockload to the load handling device, which after repeated application may cause wear or damage to both the wheels and the tracks. The impact from the wheels is passed to the body of the load handling device, and in the worst case can reduce the expected life of internal components of the load handling device. Use of a compliant track element eliminates these shockloads and provides a much smoother ride for the load handling device, significantly reducing effects of wear.

It is very important for the load handling devices and/or a control system to know the respective locations of the load handling devices on top of the grid framework structure. This location or position information may enable the load handling devices to travel to specific stacks and retrieve particular containers, to avoid collisions with other load handling devices, and/or to avoid moving beyond the boundaries of the grid framework structure. The load handling devices may therefore comprise means to detect their position and/or velocity on the grid, as described in UK patent application number GB2020681.9. This function may be provided by a wheel encoder for measuring the speed of one or more wheels of a load handling device. In some applications the wheel encoder may be coupled to an additional position wheel. Rolling over the sliding plate of the prior-art expansion joint may cause the position wheel to slip or lose traction, thus compromising the accuracy of the velocity or position measurement from the wheel encoder. With a compliant track element, however, the profile of the top of the track is relatively smooth, and the wheels of the load handling device will maintain traction and not slip.

The compliant track of the invention has the further advantage of replacing one or more expansion joints with a much simpler part. Reducing the part count and complexity results in reduced costs of manufacture and installation.

The width of the interdigitated slots varies under deformation of the at least one track element.

The plurality of interdigitated slots may extend in a direction substantially perpendicular to the longitudinal direction of the at least one track element.

The slots in the at least one track element may be evenly spaced along the at least a section of the at least one track element. Even spacing has the advantage of distributing both the deformation and the applied forces along the section of the track element where the slots are located. Alternatively, the separation between the slots can be varied to tailor the deformation of the at least one track element.

In a first embodiment of the invention, the interdigitated slots may comprise a first set of slots and a second set of slots, the first set of slots being interdigitated with the second set of slots, each slot of the first and second sets of slots having an open end and a closed end, and wherein the open ends of the first and the second set of slots are on respective opposite sides of the track element. The first embodiment has the advantage that the material between the slots forms a long deformation path between the interdigitated slots. The deformation can be distributed along the deformation path, so only a small deformation of each segment of the deformation path is required to achieve a larger cumulative deformation of the track element.

In a second embodiment of the invention, the interdigitated slots may comprise a first, a second and a third set of slots, each slot of the first and second sets of slots having an open end and a closed end, and wherein the open ends of the first and the second sets of slots are on respective opposite sides of the at least one track element, and wherein the third set of slots are closed-ended slots having closed ends, such that the third set of slots are interdigitated with the first and second sets of slots. The first and second sets of slots may comprise pairs of open-ended slots such that the open ends of the pairs of open-ended slots are directly opposite each other at opposing sides of the track section.

The second embodiment has the advantage that the arrangement of slots is symmetrical about the longitudinal axis of the slot element, so the deformation is kept central, and the track element has lower susceptibility to undesired deformations in other directions (e.g. bending).

The closed ends of the interdigitated slots may have a round profile. The advantage of a round profile is that there are no sharp corners which act as stress concentrators. Without rounding the slot ends (for example, where the ends have a square profile), sharp corners would concentrate the stress, so the track element would not be able to deform so far before reaching its elastic limit.

The closed ends of the interdigitated slots may have a keyhole profile. As with a round profile, the advantage of a keyhole profile is that there are no sharp corners which act as stress concentrators.

The track system may comprise a first section and a second section, each section of the first and second sections comprising a first set of tracks extending in a first direction and a second set of tracks extending in a second direction, the second direction being substantially perpendicular to the first direction, wherein the first and second sections of the track system are joined by a linkage comprising the at least one track element comprising interdigitated slots such that the linkage between the first and section sections of the track system is compliant.

Since different fulfilment centres have different size grid framework structures, the total cumulative displacement of the track system due to thermal expansion or contraction will be different for different fulfilment centres. Fulfilment centres exist in a wide range of different sizes, from micro- or mini-fulfilment centres as convenience stores to serve urban areas, to very large fulfilment centres such as Ocado's customer fulfilment centre at Erith, which occupies an area of around 600000 square feet.

The advantage of a modular grid framework structure, with the track system divided into sections, with compliant track elements between the sections, is that the available expansion and contraction scales with the size of the grid framework structure. The same design of compliant track element can be used for different sizes of grid framework structure in different fulfilment centres. A traditional expansion joint would need to be redesigned for each fulfilment centre to account for different cumulative displacements, therefore incurring extra development time and costs.

To make the track system fully scalable to any size of grid framework structure, the track system may be divided into sections of a standard size, and different numbers of sections used for different sizes of grid framework structure. For example, if a section of the track system has a standard size of 50×50 grid cells, four sections can be used for a grid framework structure of size 101×101 grid cells, in each direction there will be 50 grid cells of one section, with the compliant linkage between the sections forming one grid cell in the middle, then 50 grid cells of another section. Other sizes can be formed from different numbers of sections of the track system, for example 152×152 grid cells from nine sections, 203×203 grid cells from sixteen sections, or any other required size. The same design of track system sections and compliant linkages can therefore be used for a wide range of different sizes of grid framework structures, and therefore a wide range of sizes of fulfilment centres.

The at least one track element may comprise two or more track elements.

The at least one track element may be cast or machined or extruded. The interdigitated slots may be machined into the at least one track element. The at least one track element may be made of metal or plastic. Any other suitable material may be used.

The advantage of achieving the required compliance by the arrangement of slots rather than by the choice of material is that the compliant track elements can be made of the same material as standard track elements. This has the advantage that compliant track elements can use the same materials and same basic design as standard rigid track elements, the only difference being that the subset of track elements that are required to be compliant have the interdigitated slots machined into them.

The at least one track element may be supported by track supports connected together by at least one connecting member, the at least one connecting member being configured, in use, to slide relative to at least one of the track supports such that the track supports move relative to each other in a longitudinal direction.

The invention also encompasses a grid framework structure for a storage and retrieval system, comprising a track system as described above, supporting framework structure supporting the track system, and a plurality of stacks of containers arranged in storage columns located below the track system.

The invention also encompasses a storage and retrieval system, comprising the grid framework structure as described above, and one or more load handling devices for lifting and moving containers stacked in the stacks, each load handling device comprising a wheel assembly for moving the load handling device on the track system, a container-receiving space located above the track system, and a lifting device arranged to lift a single container from a stack into the container-receiving space.

### BRIEF DESCRIPTION OF THE DRAWINGS

The invention will now be described in detail with reference to examples, in which:

FIG. 1 schematically illustrates a grid framework structure and containers;

FIG. 2 schematically illustrates track on top of the grid framework structure illustrated in FIG. 1;

FIG. 3 schematically illustrates load-handling devices on top of the grid framework structure illustrated in FIG. 1;

FIG. 4 schematically illustrates a single load-handling device with container-lifting means in a lowered configuration;

FIG. 5 schematically illustrates cutaway views of a single load-handling device with container-lifting means in a raised and a lowered configuration;

FIG. 6 schematically illustrates a prior-art expansion joint;

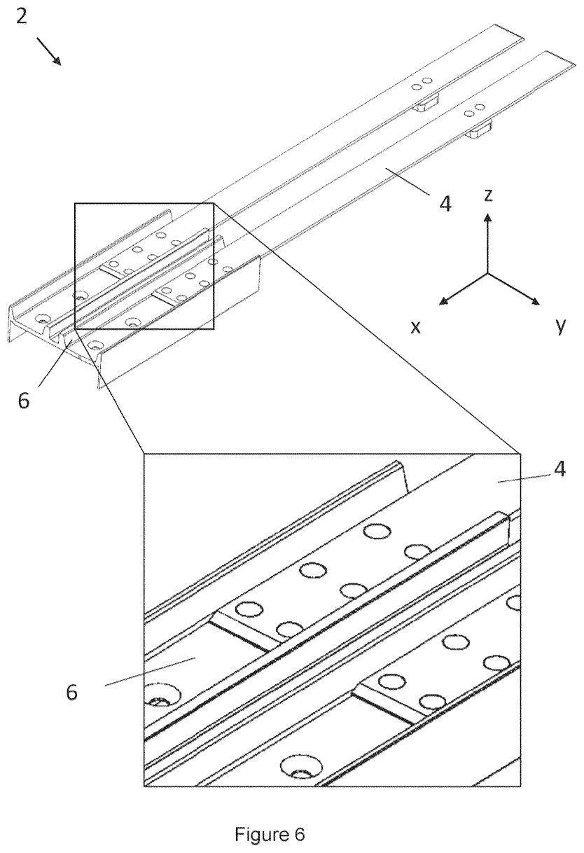

FIG. 7 schematically illustrates a compliant track element according to a first embodiment of the invention;

FIG. 8 is a top view of the compliant track section of FIG. 7;

FIG. 9 schematically illustrates a compliant track element according to a second embodiment of the invention;

FIG. 10 is a top view of the compliant track element of FIG. 9;

FIG. 11 illustrates the path of deformation of a compliant track element for (a) the first embodiment and (b) the second embodiment of the invention.

FIG. 12 illustrates a compliant track element according to the first embodiment of the invention under (a) tension and (b) compression.

FIG. 13 illustrates a compliant track element according to the second embodiment of the invention under (a) tension and (b) compression.

FIG. 14 illustrates a closed end of a slot with (a) square profile (b) round profile (c) keyhole profile.

FIG. 15 illustrates the interdigitated slots in the track element of the first embodiment with (a) wider and (b) narrower gaps between the closed ends of the slots and the sides of the track element.

FIG. 16 illustrates the interdigitated slots in the track element of the second embodiment with (a) wider and (b) narrower gaps between the closed ends of the slots and the sides of the track element.

FIG. 17 illustrates a track system comprising four sections connected by compliant linkages.

FIG. 18 illustrates a compliant track element supported by track supports, in (a) isometric view, and (b) side view.

### DETAILED DESCRIPTION

The following embodiments represent the applicant's preferred examples of how to implement a compliant track element, but they are not necessarily the only examples of how that could be achieved.

### Storage and Retrieval Systems

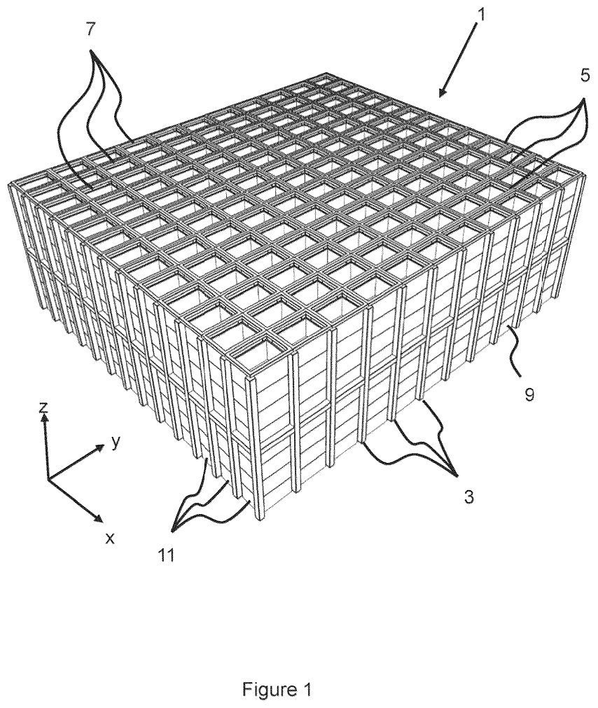

FIG. 1 illustrates a grid framework structure 1 for a storage and retrieval system. The grid framework structure comprises a track system 13, comprising a first set of tracks 17 extending in a first direction, and a second set of tracks 19 extending in a second direction. The tracks 17, 19 of the track system 13 are arranged in a grid pattern comprising a plurality of grid cells 14. The track system 13 is supported on top of a supporting framework structure. The supporting framework structure creates a storage space underneath the track system 13, comprising a plurality of storage columns 10. Each storage column 10 is arranged to store a stack of storage containers.

In the specific example illustrated in FIG. 1, the grid framework structure 1 comprises upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

The supporting framework structure as illustrated in FIG. 1 can be referred to as a “stick-built” design, comprising upright members 3 supporting horizontal grid members 7, 9. PCT Publication No. WO2015/185628A (Ocado), hereby incorporated by reference, describes in detail a “stick-built” grid structure for a storage and fulfilment or distribution system in which stacks of containers are arranged within a grid framework structure. The containers are accessed by load handling devices remotely operative on tracks located on the top of the grid framework structure.

The supporting framework structure is not limited to the “stick-built” design, and can include other types of supporting grid framework structures. In other examples, the support framework structure may comprise a plurality of prefabricated modular panels arranged in a grid pattern, further detail of which is described in the PCT application WO2022/034195A1 (Ocado), hereby incorporated by reference. This grid framework structure addresses the problem of time and cost to assemble by providing a supporting framework structure comprising a plurality of prefabricated modular panels arranged in a three dimensional grid pattern to define a plurality of grid cells. Each of the grid cells of the supporting framework structure is sized to support two or more grid cells of the track system. The grid framework structure is formed from fewer structural components yet still maintains the same structural integrity as the “stick-built” grid framework structure described above, and is much faster and cheaper to build.

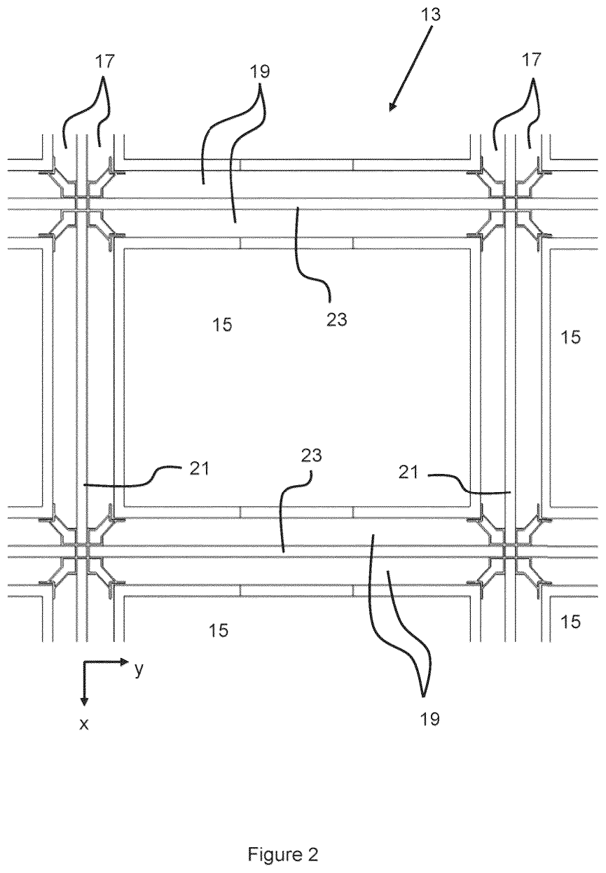

FIG. 2 shows a large-scale plan view of a section of track structure 13 forming part of the grid framework structure 1 illustrated in FIG. 1 and located on top of the horizontal members 5, 7 of the grid framework structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

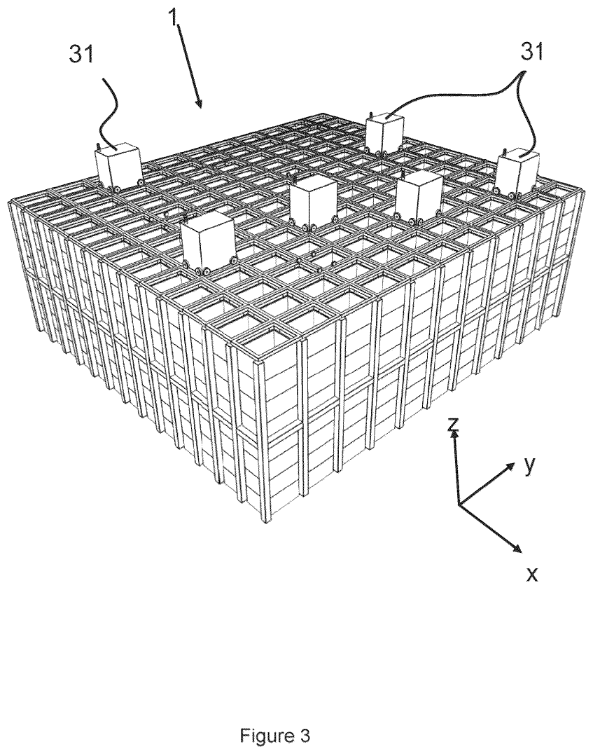

FIG. 3 shows a plurality of load-handling devices 31 moving on top of the grid framework structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

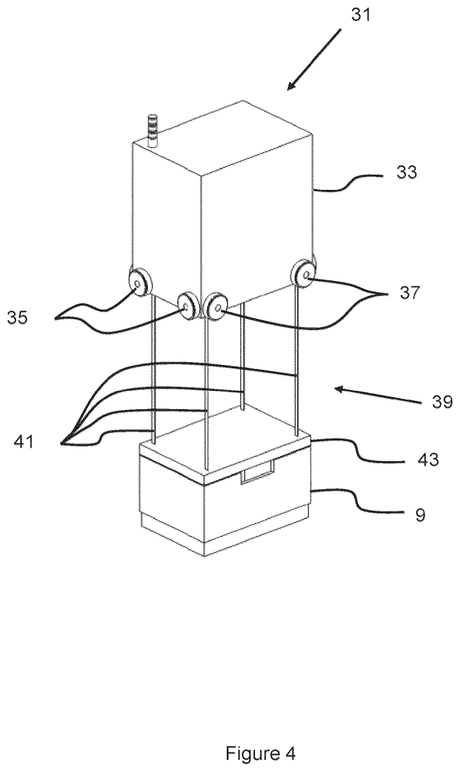

As illustrated in detail in FIG. 4, a bot 31 comprises a body 33 in or on which are mounted one or more components which enable the bot 31 to perform its intended functions. These functions may include moving across the grid framework structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43.

The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

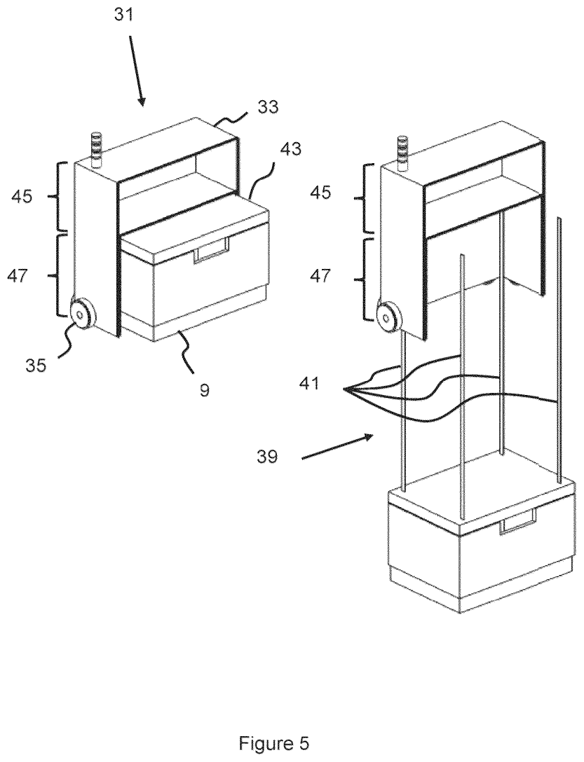

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of grid framework structure 1 without the underside of the container 9 catching on the track structure 13 or another part of the grid framework structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the grid framework structure 1 (or an ingress point of the grid framework structure 1 if the bot 31 has moved to collect a container 9 for grid framework in the grid framework structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33 of the bot 31, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

The specific example of a load handling device illustrated in FIGS. 4 and 5 shows the load handling device 31 with a body 33 that is substantially box-shaped with four sidewalls and a top wall, with the components of the load handling device 31 housed within the body 33. In other examples the body 33 may comprise an open frame or skeleton structure, within or upon which components of the load handling device 31 are supported.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the grid framework structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

### Track System

The track system 13 is supported by the supporting framework structure. In examples where the supporting framework structure is a “stick-built” supporting framework structure, the upright columns of the grid framework structure are interconnected at their top ends by the rails or tracks intersecting in the grid framework structure. The rails or tracks can be supported by the horizontal members 5,7 or integrated into the horizontal members 7,9. In examples where the supporting framework structure comprises a plurality of prefabricated modular panels, each of the grid cells of the supporting framework structure is sized to support two or more grid cells of the track system.

The intersections of the rails or tracks in the grid structure are generally termed ‘nodes’ of the track system. Typically, the first and second set of tracks comprise individual elongated rail or track elements that are interconnected together in the first and second direction at the interconnections where the track elements meet.

The tracks typically comprise an elongated element which is profiled to guide a load handling device on the track system. Typically, the tracks are profiled to provide either a single track surface so as to allow a single load handling device to travel on the track, or a double track so as to allow two load handling devices to pass each other on the same track. In the case where the elongated element is profiled to provide a single track, the track comprises opposing lips (one lip on one side of the track and another lip at the other lip at the other side of the track) along the length of the track to guide or constrain each wheel from lateral movement on the track. In the case where the profile of the elongated element is a double track, the track may comprise two pairs of lips along the length of the track to allow the wheels of adjacent load handling devices to pass each other in both directions on the same track. Alternatively, as disclosed in UK patent application no. GB2016097.4 (Ocado), a double track may comprise only two guide surfaces or lips extending from the track surface, rather than two pairs of lips.

The current invention is applicable to both single tracks and double tracks, and can be applied to any shape or profile of track elements.

### Compliant Track—Embodiments

The compliant track 50 of the current invention comprising interdigitated slots 52 will now be described with respect to the figures. Two illustrative embodiments are described, though it will be appreciated that many different patterns of interdigitated slots are possible and all fall within the scope of the invention.

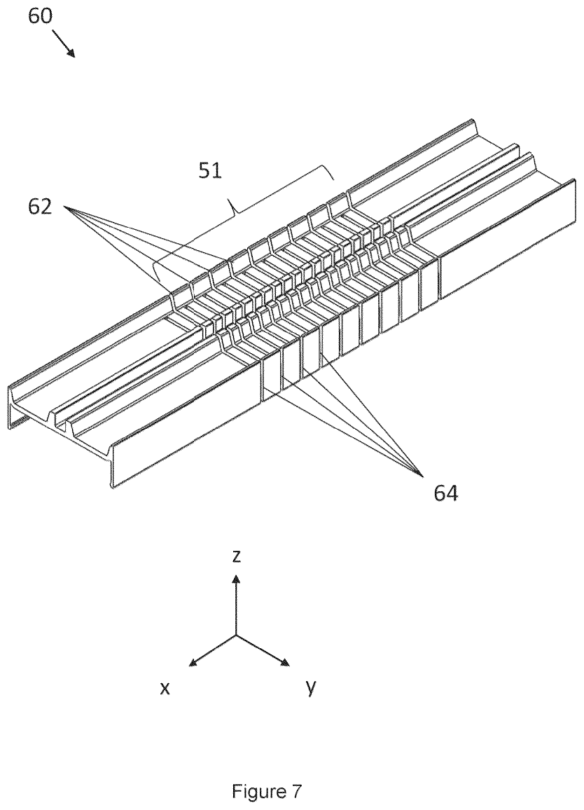

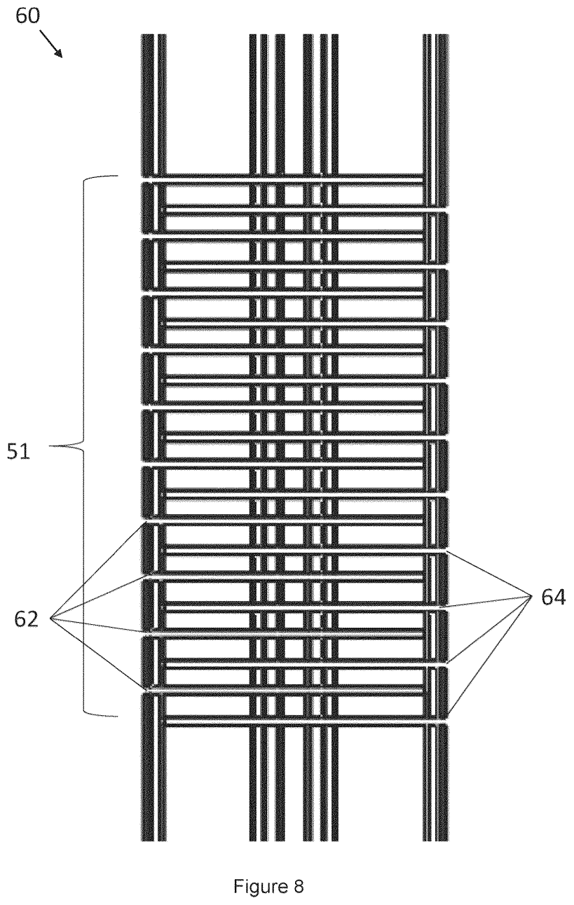

FIG. 7 illustrates a compliant track element 60, according to a first embodiment of the invention. FIG. 8 is a top view of the track element of FIG. 7. The compliant track 60 comprises a plurality of slots 52. The slots lie in planes substantially parallel to one another, and substantially perpendicular to the main longitudinal axis of the track, and therefore the direction of travel of a load handling device on the track. The slots 52 are evenly spaced within a section 51 of the compliant track element. The slots 52 are open-ended slots, each slot 52 having an open end 54 or mouth at a side of the track, and a closed end 56 inside the body of the track section. The slots are interdigitated, in the sense that adjacent slots 52 have their open ends 54 at opposite sides of the track. The body of the track forms a deformation path 66 in a zigzag shape between the interdigitated slots 52.

The slots 52 can be divided into a first set of slots 62 and a second set of slots 64. The first set of slots 62 have their open ends on the same side of the track. The second set of slots 64 have their open ends on the opposite side of the track from the side with the open ends of the first set of slots 62. The slots are arranged in alternating pattern, such that each slot from the first set of slots 62 is directly between two slots from the second set of slots 64, and each slot from the second set of slots 64 is directly between two slots from the first set of slots 62, with the exception of the first and last slots in the series of slots, which are each adjacent to one other slot only.

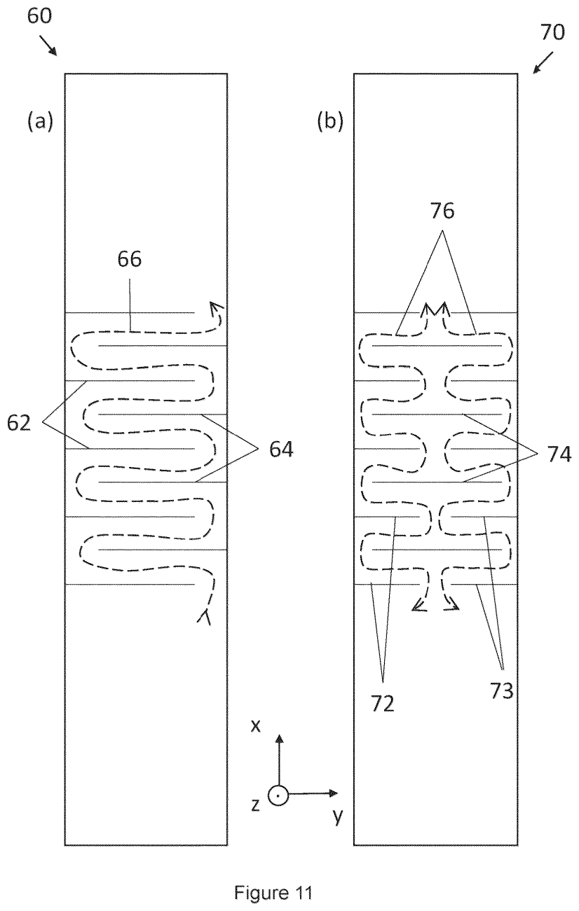

The track element is a compliant mechanism, and the arrangement of slots enables the track element to be compliant even though the material from which the track is made is rigid rather than compliant. Compliant mechanisms permit deformation in rigid materials, within the elastic limit. The deformation path 66 (shown in FIG. 11) between the interdigitated slots provides a longer path through which structural forces can be spread, and through which the track can deform. Thus the deformation of the track is spread evenly along the whole length of the section 51 of the track element containing the interdigitated slots, and allows a greater expansion/contraction while remaining within the elastic limit of the material. Remaining within the elastic limit of the material means that the deformation is fully reversible with no permanent change to the track material as it undergoes deformation.

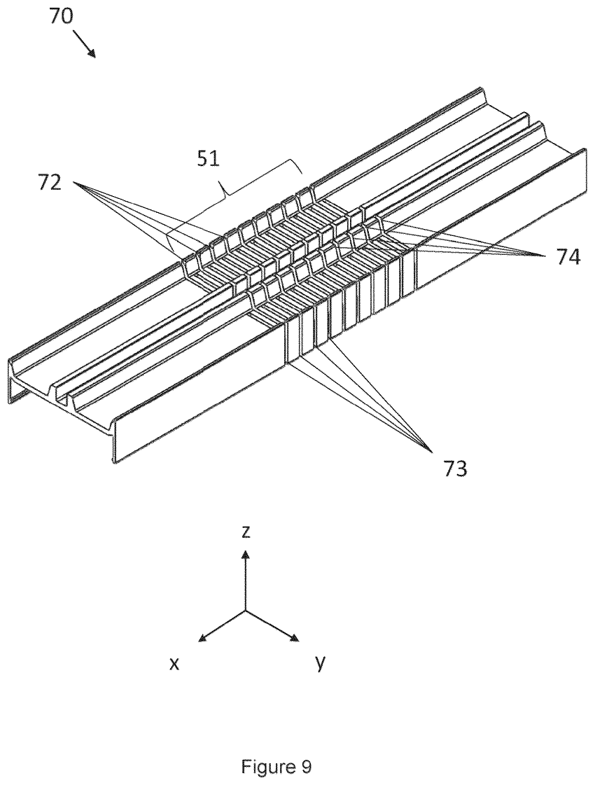

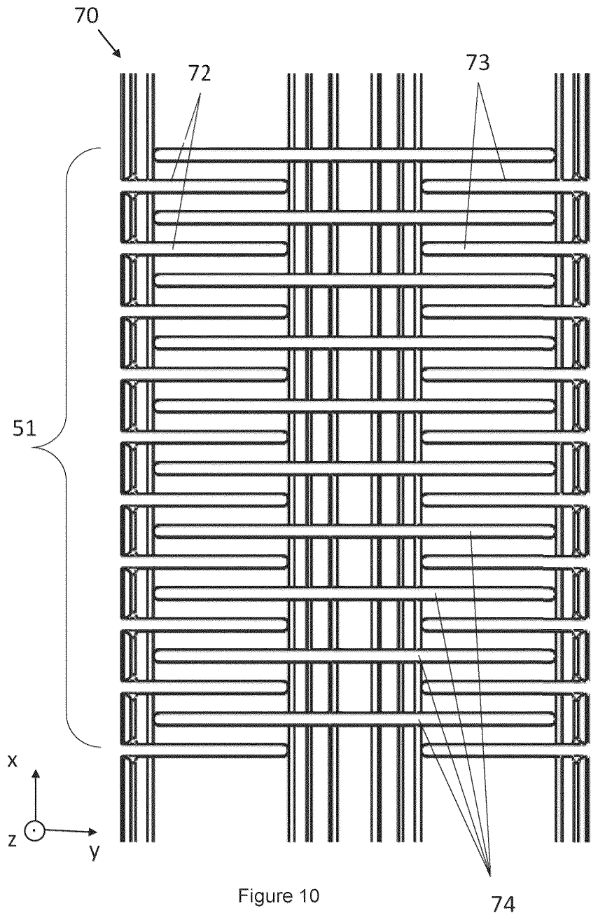

FIG. 9 illustrates a second embodiment of the invention, which is more resistant to bending than the first embodiment. FIG. 10 is a top view of the compliant track element of FIG. 9. The compliant track 70 comprises a plurality of slots 52. As with the first embodiment, the slots lie in planes substantially parallel to one another, and substantially perpendicular to the longitudinal axis of the track element 70, and therefore the direction of travel of a load handling device on the track. The slots 52 are evenly spaced within a section 51 of the compliant track element.

The slots 52 are divided into a first set of slots 72, a second set of slots 73, and a third set of slots 74. The first and second sets of slots 72, 73 are open ended, having an open end and a closed end, the open end or mouth being at respective opposing sides of the track element 70 (the first set of slots 72 at a first side of the track element and the second set of slots 73 at an opposing second side of the track element), and the closed end within the body of the track element. The third set of slots 74 are closed-ended, having two closed ends within the body of the track element 70. The first and second sets of slots 72, 73 are arranged in pairs, with each pair of slots lying in the same plane with the open ends of each pair of slots at opposite sides of the track element 70. The third set of slots 74 are arranged in alternating pattern with the first and second sets of slots 72, 73, such that each slot from the third set of slots 74 is directly between two pairs of slots from the first and second set of slots 72, 73, with the exception of the first slot in the third set of slots, which is adjacent to one pair of slots only.

FIG. 11 illustrates the deformation paths in the compliant track element of (a) the first embodiment, and (b) the second embodiment. In the first embodiment illustrated in FIG. 11(a), the deformation path 66 is shown interweaving between the first and second sets 62, 64 of interdigitated slots. In the second embodiment illustrated in FIG. 11(b), there are two deformation paths 76 on opposite sides of the track element 70. The deformation paths are substantially symmetrical. The deformation path 76 on the left hand side of the track element 70 interweaves between the first set of slots 72 and the third set of slots 74, and the deformation path 76 on the right hand side of the track element 70 interweaves between the second set of slots 73 and the third set of slots 74. The two deformation paths 76 pass either side of the third set of slots 74.

The main advantages of the first embodiment are that open-ended slots are easier to manufacture than closed-ended slots, and the single deformation path provides a longer deformation path than embodiments with multiple deformation paths. A longer deformation path means that the deformation is spread across a greater length, so each section of material along the path can deform less and still achieve the required cumulative deformation along the whole path. The main advantage of the second embodiment is that the closed-ended slots and symmetrical arrangement of slots gives the design more stability. The track element of the second embodiment is more torsionally stable, keeps the deformation more central/linear, and is less susceptible to undesired deformation such as bending and twisting.

Both the first and second embodiments of the invention, or any other pattern of interdigitated slots, can be applied to either a single track or a double track. Other embodiments of the invention are possible with more than two deformation paths, for example three or four deformation paths. Even numbers of symmetrical deformation paths may provide greater stability and resist deformation in directions other than along the longitudinal direction of the track element (for example, bending or torsion). It will be appreciated that there are many possible patterns of interdigitated slots, and different patterns of interdigitated slots may be suitable for different deformation requirements or different levels of thermal expansion/contraction. The first and second embodiments described above are examples only, and any pattern of interdigitated slots is within the scope of the invention.

### Deformation

When the temperature of the environment increases, the track system will undergo thermal expansion. The compliant track element(s) will need to contract to compensate for expansion within the rest of the track system. The compliant track element(s) will therefore be under compression. The interdigitated slots become narrower as the material either side of the slots is pressed closer together along the longitudinal axis of the track element. The limiting factor on compression is when the slots close, as the width of the slot approaches zero.

Under compression, open-ended slots will get narrower at the open end than at the closed end. Closed-ended slots get narrower towards the middle of the slots than at the closed ends.

When the temperature of the environment drops, the track system will undergo thermal contraction. The compliant track section(s) will need to expand to compensate for contraction within the rest of the track system. The compliant track element(s) will therefore be under tension. The interdigitated slots become wider as the material either side of the slots is pulled further apart along the longitudinal axis of the track element.

Under tension, open-ended slots get wider at the open end than at the closed end. Closed-ended slots get wider towards the middle of the slots than at the closed ends.

In both cases (tension and compression), deformation is such that the width of the slot varies along the length of the slot.

In addition to thermal expansion and contraction, the compliant track element(s) may also be under tension and/or compression because of other movement in the track system or the underlying grid framework structure, for example due to seismic activity.

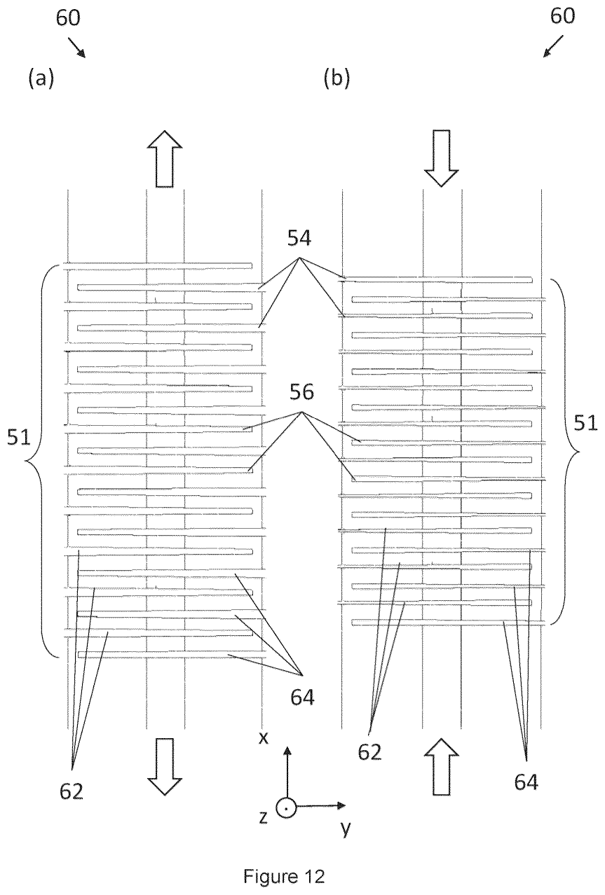

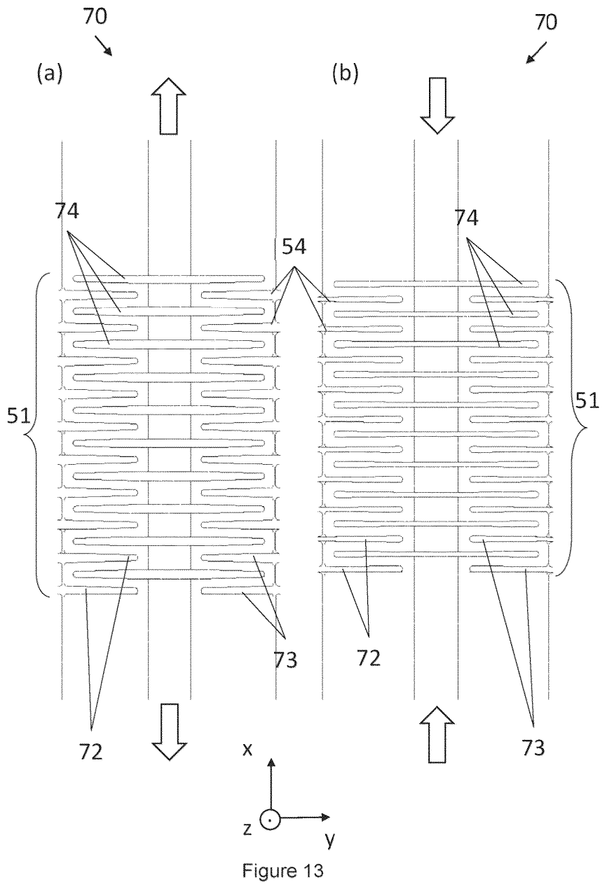

FIGS. 12 and 13 illustrate the deformation of a compliant track element under tension and compression, with the direction of the applied force being indicated by the arrows. FIG. 12(a) illustrates the first embodiment 60 of the compliant track element under tension. It can be seen from the figure that the first and second sets 62, 64 of interdigitated slots have deformed to become wider, such that the open ends 54 of the slots are wider than the closed ends 56 of the slots. The section 51 of the compliant track occupied by the interdigitated slots 62, 64 has increased in length along its longitudinal axis.

In contrast, when the first embodiment 60 of the compliant track is under compression as shown in FIG. 12(b), the first and second sets 62, 64 of interdigitated slots have deformed to become narrower, such that the open ends 54 of the slots are narrower than the closed ends 56 of the slots. The section 51 of the compliant track occupied by the interdigitated slots 62, 64 has decreased in length along its longitudinal axis.

FIG. 13(a) illustrates the second embodiment 70 of the compliant track element under tension. It can be seen from the figure that the first, second, and third sets 72, 73, 74 of interdigitated slots have deformed to become wider. The open ends 54 of the first and second set of slots 72, 73 are wider than the closed ends 56 of the first and second set of slots, and the centres of the third set of slots 74 are wider than the ends. The section 51 of the compliant track occupied by the interdigitated slots 72, 73, 74 has increased in length along its longitudinal axis.

In contrast, when the second embodiment 70 of the compliant track is under compression as shown in FIG. 13(b), the first, second, and third sets 72, 73, 74 of interdigitated slots have deformed to become narrower. The open ends 54 of the first and second sets of slots 72, 73 are narrower than the closed ends 56 of the first and second sets of slots, and the centres of the third set of slots 74 are narrower than the ends. The section 51 of the compliant track occupied by the interdigitated slots 72, 73, 74 has decreased in length along its longitudinal axis.

In the case of compression, the width of the slots is a limiting factor as the slots are compressed enough to close. Compression limiters may be used in order to ensure that the track element is not subjected to more compressive stress than the track has been designed for.

The arrangement of slots in the compliant track can be designed such that the track is more compliant in some directions than others. For example, compliant tracks can be designed that can easily expand under tension and contract under compression, but are less compliant to twisting or to bending deformations.

### Design of the Interdigitated Slots

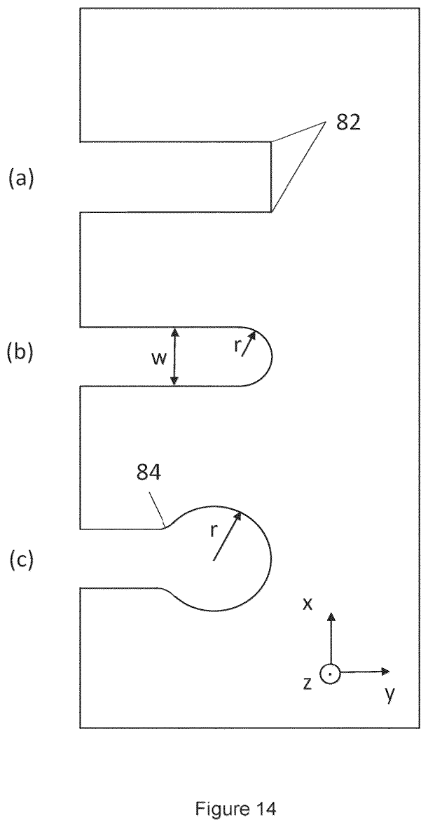

The shape of the closed ends 56 of the slots 52 is important because the slot end profile affects the stress behaviour of the compliant track element 50. The shape of the closed ends of the slots can be chosen to avoid a high stress concentration factor, e.g. by avoiding sharp corners and small features. FIG. 14 illustrates a closed end of a slot with (a) square profile (b) round profile (c) keyhole profile.

The advantage of a round or keyhole shaped profile of the slot end is that there are no sharp corners which act as stress concentrators. Without any smoothing of the slot end profile (for example, where the ends have a square profile as in FIG. 14(a)), sharp corners 82 would concentrate the stress, so the track element would not be able to deform so far before the stress at the corners reaches the fatigue stress or the elastic limit. With a round profile as in FIG. 14(b), the slot end can have a radius of curvature r equal to half of the width w of the slot. With a keyhole profile as in FIG. 14(c), the slot end can have an even larger radius of curvature. A fillet radius 84 can be applied to the slot end where the circular part of the slot profile meets the straight part of the slot profile, in order to avoid a sharp corner. These slot end profiles are examples only, many options are available for the profile of the slot ends, and any shape of slot is within the scope of the invention.

In determining the design of the interdigitated slots, there is a trade-off between the number of slots and the width of the slots. A small number of wider slots will be easier to manufacture (fewer slots for machining, and wider slots means wider tolerances so lower precision tool scan be used). Also, where slots with round or keyhole profiles are used, wider slots will have a larger radius of curvature and will therefore have a lower stress concentration factor. However, a larger number of narrower slots, though harder to manufacture, will have a reduced deformation on each one (and potentially a reduced stress induced by the deformation), as well as providing a smoother ride for the wheels of the load handling device running over the track.

The length of the slot is also an important design consideration. Longer slots have the advantage of forming a longer deformation path, and have narrower gaps between the closed ends of the slots and the sides of the track element. A very narrow gap with a small amount of material is similar to a living hinge arrangement, and a track element where all of the slots are long and the gaps are narrow is like a series of living hinges, where each of the gaps acts like a single living hinge.

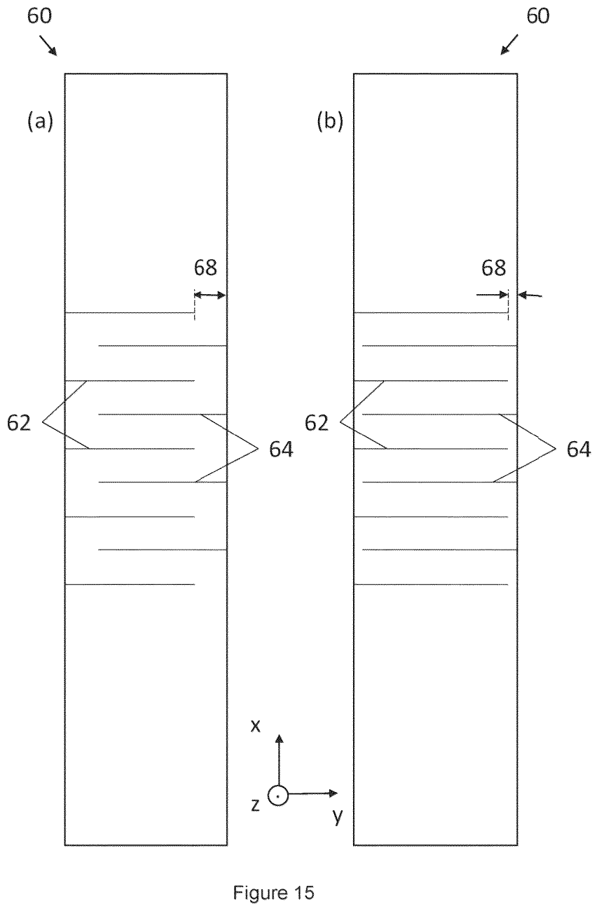

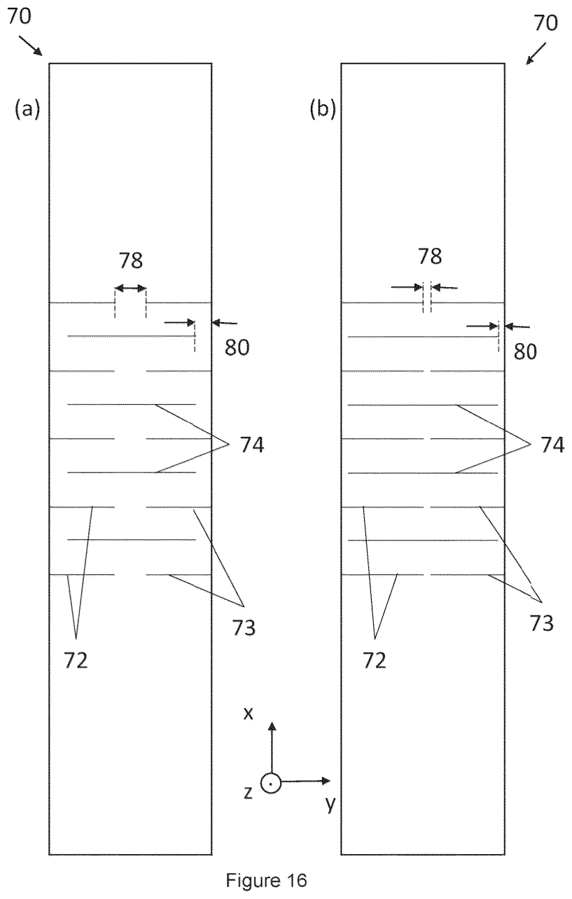

The difference between wide and narrow gaps is illustrated in FIGS. 15 and 16. FIG. 15 illustrates the interdigitated slots in the track element of the first embodiment with (a) wider and (b) narrower gaps. The gaps 68 are between the closed ends of the interdigitated slots and the sides of the track element. The first set of slots 62 with open ends on the left hand side of the track element have gaps 68 at the right hand side of the track element, and the second set of slots 64 with open ends on the right hand side of the track element have gaps 68 at the left hand side of the track element. In FIG. 15(b) with the narrower gaps 68, the living hinges at the narrow gaps 68 are located at the turning points of the deformation path 66 illustrated in FIG. 11.

FIG. 16 illustrates the interdigitated slots in the track element of the second embodiment with (a) wider and (b) narrower gaps. In this embodiment there are two sets of gaps: a first set of gaps 78 between the closed ends of the pairs of the first set of slots, and a second set of gaps 80 between the closed ends of the second set of slots and the sides of the track element. As for the first embodiment, in FIG. 16(b) with the narrower gaps 78, 80 the living hinges at the narrow gaps 78, 80 are located at the turning points of the deformation paths 76 illustrated in FIG. 11.

The length of the slots also affects manufacturability. In living-hinge type arrangements where the gaps 68, 78, 80 are narrow, the tolerances are important and the machining of the slots must be done with precision, which may require more specialist tooling than for machining wider gaps. Also the track profile is relevant here, it may be easier to machine slots into thinner or less deep parts of the track than through thicker or deeper parts such as the upwardly extending lips of the tracks. For example, in FIGS. 7 and 9 it can be seen that the slots end just before the outer upwardly extending lips at the edges of the track.

The compliant track element must be designed to always stay within the elastic limit of the material of which the track is constructed, in order to avoid permanent deformation. A safety factor can be multiplied by the yield stress of the material to calculate a maximum allowable stress. The yield stress is the stress at which the material reaches its elastic limit, beyond which the material may be permanently deformed.

The compliant track element can be designed to withstand fatigue. The maximum allowable stress for fatigue can be calculated for a desired lifetime of the track (for example, 20 years). In general, the fatigue stress will be lower than the elastic limit, so designing for fatigue will ensure that the deformation always remains within the elastic limit. Fatigue stress can be determined by, for example, calculating the expected number N of expansion-contraction cycles over the expected lifetime of the track (e.g. caused by daily cycles in temperature) and reading the stress from an S-N curve of the material. If different levels of stress or deformation are expected due to different kinds of loading (for example, small deformations due to daily temperature cycles, annual seasonal temperature variation, and less frequent seismic activity), then Miner's rule can be used to calculate the cumulative effect of different magnitudes of stresses with different numbers of cycles, in order to calculate the maximum allowable stress for the desired fatigue life. Once a maximum allowable stress has been calculated, this stress value may be multiplied by a safety factor.

The skilled person will appreciate that other methods of calculating fatigue life and maximum allowable stress exist (e.g. stress-life methods, strain-life methods, crack growth methods, and probabilistic methods), the example described above is intended to be a non-limiting example only, and any suitable method can be used.

A target temperature range can be determined based on the expected maximum and minimum temperatures. The maximum expected expansion/contraction of the grid can then be calculated, using the target temperature range and the thermal expansion coefficient of the material that the tracks are made of.

The change in linear dimension ΔL of a track is given by:

$$\frac{Δ L}{L} = α \frac{Δ T}{T}$$

where L is the nominal length of the track along its longitudinal axis, a is the coefficient of linear thermal expansion (a property of the material), ΔT is the change in temperature, and T is the nominal temperature. The change in length ΔL can be calculated for the full width or length of the track system. For large track systems where multiple compliant track elements are used to absorb deformation, the total change in length can be divided by the number of compliant track elements along that dimension, to calculate the required expansion or contraction per compliant track.

When the required deformation and maximum allowable stress are known, the compliant track element can be modelled (e.g. with finite element methods) to ensure that the design of the track element with interdigitated slots is appropriate for the desired fatigue life. With finite element methods, the required deformation can be applied to the model of the track element and the stress calculated throughout the material. If the calculated stress is too high (above the maximum allowable stress), then the design can be changed and the analysis repeated until a design is found where the stress is below the maximum allowable stress. Design parameters that can be changed include the number of slots, slot width, slot length, slot spacing, profile of the closed ends of the slots, distance between the closed ends of the slots and the sides of the track element, and the material used.

One approach to the design is to maximize the deformation per slot, within the fatigue and elastic limits. This can be done by approaching the maximum allowable stress form either direction: either starting with a design where the stress is too high and then changing the design to reduce the stress, as described above, or starting with a design where the stress is below the maximum allowable stress and then changing the design to increase the stress. There are trade-offs between stress and other design targets; for example, increasing the stress while keeping it low enough to meet fatigue life can result in a design that is easier to manufacture (e.g. with fewer or wider slots). Finding the optimum design is a matter of balancing different (and sometimes competing) design targets in order to create a design that appropriately balances stress, expected lifetime, noise and vibration performance, costs, and ease of manufacture.

### Materials and Manufacturing

The tracks can be made from any suitable material, including metals (e.g. aluminium). Since the tracks are elongated elements with a constant profile along their length, they can be formed by extruding. Alternatively, the track elements can be cast.

Plastic is another option for the material; it is less expensive, deforms more easily, but is more prone to wear.

The slots can be formed by machining, by water or laser cutting, by EDM (electrical discharge machining), or any other appropriate method.

Track System with Compliant Track Elements

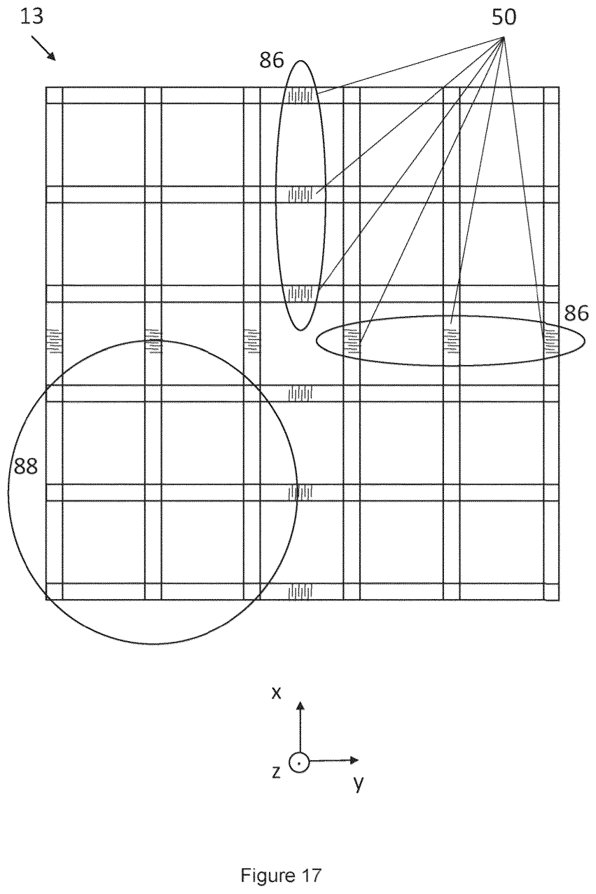

FIG. 17 schematically illustrates a track system 13 comprising four sections 88, with the sections joined by linkages 86. The linkages 86 comprise compliant track elements 50, therefore the linkages 86 are compliant and the sections 88 of the track system 13 are able to move relative to one another. The track elements within each of the sections 84 of the track system 13 are rigid track elements.

Each of the four sections 88 of the track system 13 comprises a first set of tracks 17 extending in a first direction (x-direction) and a second set of tracks 19 extending in a second direction (y-direction), the second direction being substantially perpendicular to the first direction. The four sections 88 of the track system are joined by linkages 86 comprising compliant track elements 50 comprising interdigitated slots, such that the linkages 86 themselves are compliant.

As described above, the advantage of dividing the track system into sections, with compliant linkages between the sections, is that the available expansion/contraction scales with the size of the track system and the same design of compliant track element can be used for different sizes of track system in different fulfilment centres.

In the example shown in FIG. 17, the track system 13 is divided into four sections 88 of size 2×2 grid cells. Four sections of size 2×2 comprise a track system of size 5×5 grid cells, with the compliant linkages 86 between the sections 88 forming one row and one column of grid cells in the middle, between the sections 88. Other sizes of track system can be formed from different numbers of sections 88, for example 8×8 grid cells from nine 2×2 sections, 11×11 grid cells from sixteen 2×2 sections, or any other required size. The same design of track system sections and compliant linkages can be used for a wide range of different sizes of track system, and therefore a wide range of sizes of grid framework structures and fulfilment centres.

For ease of illustration, the sections 88 of the track system in FIG. 17 are small sections of 2×2 grid cells. In practice, much larger sections (e.g. 20×20, 40×40, or 100×100 grid cells, or any other size) may be used, and any number of sections of track system may be joined with compliant linkages to form the required size of track system.

### Track Supports

The compliant track elements 50 may be supported underneath by horizontal members to prevent deformation by bending. The track elements can be configured to slide over the top of the supporting horizontal member. Alternatively, sliding bearings can be used.

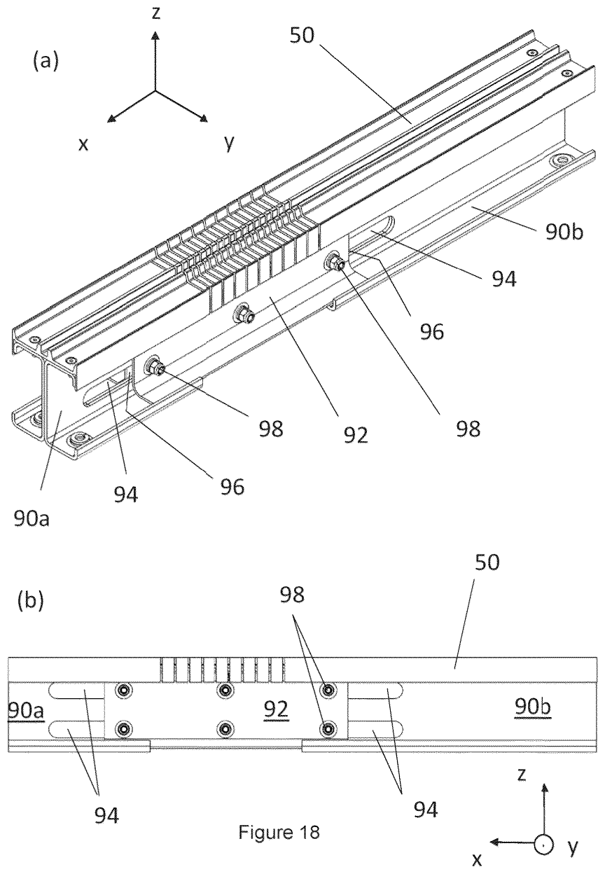

One method of supporting the compliant track element is illustrated in FIG. 18(a and b). The compliant track section 50 is supported by track supports 90. There are two track supports 90a and 90b, one supporting each end of the compliant track element 50. The track supports 90a and 90b are connected by a connecting member 92, located at the sides of the track supports 90. The connecting member 92 can be formed in one piece comprising two elongated sections either side of the track supports connected by a bridge, or the connecting member can comprise a pair of members at either side of the track supports. The connecting member 92 overlaps the track supports 90 along their longitudinal axis. The track supports 90 comprise slots 94 cut into the track supports 90, extending in the direction of the longitudinal axis of the track support. The track supports 90 are attached to the connecting member 92 via sliders 96 which sit within the slots 94. The sliders 96 are connected to the connecting member 92 via bolts 98. This allows the two track supports 90a and 90b to move along their longitudinal axis, as the sliders 96 slide along the length of the slots 94 in the track supports 90.

The sliding arrangement illustrated in FIG. 18(a and b) allows the compliant track element 50 to expand and contract along its longitudinal axis, while limiting movement in any other direction. When the compliant track element 50 expands, the sliders 96 slide along the slots 94 and allow the two track supports 90a and 90b to move apart. FIG. 18(b) illustrates two sets of slots and sliders at different heights, one located above the other. An advantage of this arrangement is that it helps to constrain the motion of the track supports to the longitudinal axis.

Although four sliders 96 and four slots 94 are illustrated in FIG. 18(a and b), one slider 96 in each slot 94, in other embodiments there may be different arrangements or numbers of sliders 96 and slots 94. There may be more than one slider in each slot. The slots 94 in FIG. 18(a and b) are positioned along the longitudinal axis of the track supports 90, but in other embodiments the slots may be positioned differently. For example, there may be be a pair of parallel slots disposed at opposite sides of the track supports 90. A single slider 96 moving within a single slot 94 is sufficient in order to provide the relative motion of the two track supports 90a, 90b.

In order to reduce wear and facilitate low-friction sliding, the contacting surfaces (the outer edges of the sliders 96, and the inner surface of the slots 94) may be coated with a low-friction material such as PTFE.

As an alternative to the sliding arrangement illustrated in FIG. 18, the compliant track element 50 may be resting directly on top of and configured to slide relative to one or more track supports, or the compliant track element 50 may be supported by sliding bearings, or the track supports may be connected in a pivoting arrangement, or the compliant track element 50 may be supported on rollers arranged on top of one or more track supports, or any other suitable mechanism may be used.

### Definitions

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

1-16. (canceled)

17. A track system for a storage and retrieval system, the track system comprising:
a first set of tracks extending in a first direction, and a second set of tracks extending in a second direction, the second direction being substantially perpendicular to the first direction, each of the first and second sets of tracks including a plurality of track elements;
wherein at least a section of at least one track element of the first and/or second sets of tracks includes a plurality of interdigitated slots such that the at least one track element is compliant.

18. The track system of claim 17, wherein the at least one track element is configured such that a width of the interdigitated slots will vary under deformation of the at least one track element.

19. The track system of claim 17, wherein the plurality of interdigitated slots extend in a direction substantially perpendicular to a longitudinal direction of the at least one track element.

20. The track system of claim 17, wherein the interdigitated slots in the at least one track element are evenly spaced along the at least a section of the at least one track element.

21. The track system of claim 17, wherein the interdigitated slots comprise:
a first set of slots and a second set of slots, the first set of slots being interdigitated with the second set of slots, each slot of the first and second sets of slots having an open end and a closed end, and wherein the open ends of the first and the second sets of slots are on respective opposite sides of the at least one track element.

22. The track system of claim 17, wherein the interdigitated slots comprise:
a first, a second and a third set of slots, each slot of the first and second sets of slots having an open end and a closed end, and wherein the open ends of the first and the second sets of slots are on respective opposite sides of the at least one track element, and wherein the third set of slots are closed-ended slots having closed ends, such that the third set of slots are interdigitated with the first and second sets of slots.

23. The track system of claim 21, wherein the closed ends of the interdigitated slots have a round profile.

24. The track system of claim 21, wherein the closed ends of the interdigitated slots have a keyhole profile.

25. The track system of claim 17, comprising:
a first section and a second section, each of the first and second sections including a first set of tracks extending in a first direction and a second set of tracks extending in a second direction, the second direction being substantially perpendicular to the first direction; and
a linkage, wherein the first and second sections of the track system are joined by the linkage including the at least one track element including interdigitated slots such that the linkage between the first and section sections of the track system is compliant.

26. The track system of claim 17, wherein the at least one track element comprises:
two or more track elements.

27. The track system of claim 17, wherein the at least one track element is configured with a cast or machined or extruded element.

28. The track system of claim 17, wherein the interdigitated slots are configured into the at least one track element.

29. The track system of claim 17, wherein the at least one track element is made of metal or plastic.

30. The track system of claim 17, comprising:
track supports, wherein the at least one track element is supported by the track supports connected together by at least one connecting member, the at least one connecting member being configured, in use, to slide relative to at least one of the track supports such that the track supports move relative to each other in a longitudinal direction.

31. A track system according to claim 17 in combination with a grid framework structure for a storage and retrieval system, the combination comprising:
a track system of claim 17;
a supporting framework structure supporting the track system; and
a plurality of stacks of containers arranged in storage columns located below the track system.

32. A combination according to claim 31 for a storage and retrieval system, the combination comprising:
the grid framework structure of claim 31, and one or more load handling devices for lifting and moving containers stacked in the stacks, each load handling device including:
a wheel assembly configured and arranged for moving the load handling device on the track system;
a container-receiving space located above the track system; and
a lifting device configured and arranged to lift a single container from a stack into the container-receiving space.
